(19) United States
(12) Patent Application Publication
(10) Pub. No.: US 2025/0232141 A1
(43) Pub. Date: Jul. 17, 2025

(54) DYNAMIC SUMMARY ADJUSTMENTS FOR LIVE SUMMARIES

(71) Applicant: Google LLC, Mountain View, CA (US)

(72) Inventors: Vikas Bahirwani, San Francisco, CA (US); Alex Olwal, Santa Cruz, CA (US); Ruofei Du, San Francisco, CA (US); Manish Gupta, Berkeley, CA (US); Susan Xu, San Francisco, CA (US)

(21) Appl. No.: 18/862,084

(22) PCT Filed: May 10, 2023
(86) PCT No.: PCT/US2023/021765

§ 371 Date: Oct. 31, 2024

Related U.S. Application Data
(60) Provisional application No. 63/364,478, filed on May 10, 2022.

(51) Int. Cl. G06F 40/47; G06F 40/35

(52) U.S. Cl. CPC G06F 40/47; G06F 40/35

(57) ABSTRACT

Described techniques may be utilized to process transcribed text of a transcription stream using a compression ratio machine learning (ML) model to determine at least two compression ratios. The transcribed text may then be processed by a summarization ML model using the at least two compression ratios to obtain a summary stream that includes first summarized text having a first compression ratio of the at least two compression ratios, relative to a first corresponding portion of the transcribed text, and second summarized text having a second compression ratio of the at least two compression ratios, relative to a second corresponding portion of the transcribed text. The transcribed text may also be summarized by the summarization ML model based on a complexity score determined by a complexity ML model.

### CROSS REFERENCE TO RELATED APPLICATIONS

This application claims the benefit of U.S. Provisional Application No. 63/364,478, filed May 10, 2022, the disclosure of which is incorporated herein by reference in its entirety.

This application also incorporates by reference herein the disclosures to related co-pending applications, U.S. application Ser. No. 18/315,113, filed May 10, 2023, “Multi-Stage Summarization for Customized, Contextual Summaries”, filed May 10, 2023 (Attorney Docket No. 0120-533WO1), “Dynamic Summary Adjustments for Live Summaries”, filed May 10, 2023 (Attorney Docket No. 0120-534WO1), “Summary Generation for Live Summaries with User and Device Customization”, filed May 10, 2023 (Attorney Docket No. 0120-535WO1), “Summarization with User Interface (UI) Stream Control and Actionable Information Extraction”, filed May 10, 2023 (Attorney Docket No. 0120-541WO1), and “Incremental Streaming for Live Summaries”, filed May 10, 2023 (Attorney Docket No. 0120-589WO1).

### TECHNICAL FIELD

This description relates to summarization using machine learning (ML) models.

### BACKGROUND

A volume of text, such as a document or an article, often includes content that is not useful to, or desired by, a consumer of the volume of text. Additionally, or alternatively, a user may not wish to devote time (or may not have sufficient time) to consume an entirety of a volume of text.

Summarization generally refers to techniques for attempting to reduce a volume of text to obtain a reduced text volume that retains most information of the volume of text within a summary. Accordingly, a user may consume information in a more efficient and desirable manner. In order to enable the necessary processing of the text, the latter may be represented by electronic data (text data). For example, a ML model may be trained to input text and output a summary of the text.

### SUMMARY

Described techniques process input text data to reduce a data volume of the input text data and obtain output text data expressing a summary of content of the input text data. The obtained, reduced volume of the output text data may be conformed to a size of a display, so as to optimize a size of the output text data relative to the size of the display. Moreover, described techniques may accomplish such customized data volume reductions with reduced delay, compared to existing techniques and approaches. For example, described techniques apply a dynamic data reduction using a variable compression ratio when performing data reductions over a period of time.

In a general aspect, a computer program product is tangibly embodied on a non-transitory computer-readable storage medium and comprises instructions that, when executed by at least one computing device, are configured to cause the at least one computing device to receive, over a time window, a transcription stream (data stream) of transcribed text, determine a first time interval of the time window that includes first transcribed text of the transcribed text, and determine, using a compression ratio machine learning (ML) model, a first compression ratio for the first time interval. The instructions, when executed by the at least one computing device, are further configured to cause the at least one computing device to determine a second time interval of the time window that includes second transcribed text of the transcribed text, and determine, using the compression ratio ML model, a second compression ratio for the second time interval. The instructions, when executed by the at least one computing device, are further configured to cause the at least one computing device to input the transcription stream, the first compression ratio, and the second compression ratio into a summarization machine learning (ML) model to obtain a summary stream (data stream) of summarized text including first summarized text corresponding to, e.g., based on, the first transcribed text and the first compression ratio, and second summarized text corresponding to, e.g., based on, the second transcribed text and the second compression ratio.

According to another general aspect, a device includes at least one processor, at least one memory, at least one display, and a rendering engine including instructions stored using the at least one memory. The instructions, when executed by the at least one processor, cause the device to render a summary stream on the at least one display that includes first summarized text of first transcribed text of a first time interval of a transcription stream, and second summarized text of second transcribed text of a second time interval of the transcription stream, wherein the first summarized text has a first compression ratio relative to the first transcribed text that is determined by a compression ratio machine learning (ML) model, and the second summarized text has a second compression ratio relative to the second transcribed text that is determined by the compression ratio ML model.

According to another general aspect, a method includes receiving a transcription stream of transcribed text, processing the transcribed text using a compression ratio machine learning (ML) model to determine at least two compression ratios, and summarizing the transcribed text using the at least two compression ratios to obtain a summary stream that includes first summarized text having a first compression ratio of the at least two compression ratios, relative to a first corresponding portion of the transcribed text, and second summarized text having a second compression ratio of the at least two compression ratios, relative to a second corresponding portion of the transcribed text.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for dynamic summary adjustments for live summaries.

FIG. 2 is a flowchart illustrating example operations of the system of FIG. 1.

FIG. 3 is a block diagram illustrating a more detailed example implementation of the system of FIG. 1.

FIG. 4 is a flowchart illustrating example training techniques for the example of FIG. 3.

FIG. 5 illustrates example display layouts for use in the example of FIGS. 3 and 4.

FIG. 6A is a timing diagram illustrating example speech rates with corresponding summaries that are generated using the example of FIGS. 3 and 4.

FIG. 6B is a timing diagram illustrating example speech changes and corresponding phrasing treatments using the example of FIGS. 3 and 4.

FIG. 6C illustrates screenshots of an example summary generated using the timing diagrams of FIG. 6B.

FIG. 7 is a third person view of a user in an ambient computing environment.

FIGS. 8A and 8B illustrate front and rear views of an example implementation of a pair of smartglasses.

### DETAILED DESCRIPTION

Described systems and techniques enable customized, contextual summary adjustments during a live conversation between a speaker and a user. Input speech (audio data) received at a device during the live conversation may be processed using at least one trained summarization model, or summarizer, to provide a summary of the speech, e.g., a summary stream (a data stream) of captions that are updated as the speaker speaks. Then, described techniques may utilize user preferences of the user, speech characteristics of the speaker, and/or device characteristics of the device to dynamically adjust summary characteristics of the summary stream over time and during the live conversation. Accordingly, a user may have a fluid experience of the live conversation, in which the dynamically adapted summary stream assists the user in understanding the live conversation.

For example, one or more additional ML models may be trained to enable a summarizer to make the types of dynamic summary adjustments referenced above. For example, a compression ratio model may be trained to evaluate, for a given time interval of the live conversation, one or more of user preferences (e.g., as determined based on device settings chosen by a user or other operation of the device by a user), speech characteristics of a speaker, and/or device characteristics of a device, to thereby determine a compression ratio of a current summary included within the summary stream. In other examples, a complexity model may be trained to evaluate, for a given time interval of the live conversation, relevant user preferences to determine a complexity of a summary included within the summary stream.

Consequently, described techniques may be helpful, for example, when a user is deaf or heard of hearing, as the user may be provided with the summary stream visually on a display. Similarly, when the user is attempting to converse with a speaker in a foreign language, the user may be provided with the summary stream in the user's native language.

Described techniques may be implemented for virtually any type of spoken input text (text data). For example, automatic speech recognition (ASR), or other transcription techniques, may be used to provide a live transcription of detected speech, which may then be provided or available to a user as a transcription stream. Then, described techniques may be used to simultaneously provide the type of live, dynamically adjusted summarization stream referenced above, i.e., to provide the summarization stream in parallel with the transcription stream.

For example, a user wearing smartglasses or a smartwatch, or using a smartphone, may be provided with either/both a transcription stream and a summarization stream while listening to a speaker. In other examples, a user watching a video or participating in a video conference may be provided with either/both a transcription stream and a summarization stream.

Described techniques thus overcome various shortcomings and deficiencies of existing summarization techniques, while also enabling new implementations and use cases. For example, existing summarization techniques may reduce input text excessively, may not reduce input text enough, may include irrelevant text, or may include inaccurate information. In scenarios referenced above, in which a transcription stream and a summarization stream are desired to be provided in parallel, existing summarization techniques (in addition to the shortcomings just mentioned) may be unable to generate a desirable summary quickly enough, or may attempt to generate summaries at inopportune times (e.g., before a speaker has finished discussing a topic). Still further, existing techniques may generate a summary that is too lengthy (or otherwise maladapted) to be displayed effectively on an available display area of a device being used (e.g., smartglasses).

In contrast, described techniques solve the above problems, and other problems, by, e.g., analyzing spoken input while accessing user preferences and device characteristics over a period(s) of time during a live conversation. Consequently, described techniques are well-suited to generate dynamic, real-time summaries that are adapted over time during the course of one or more live conversations, while a speaker is speaking, and in conjunction with a live transcription that is also produced and available to a user.

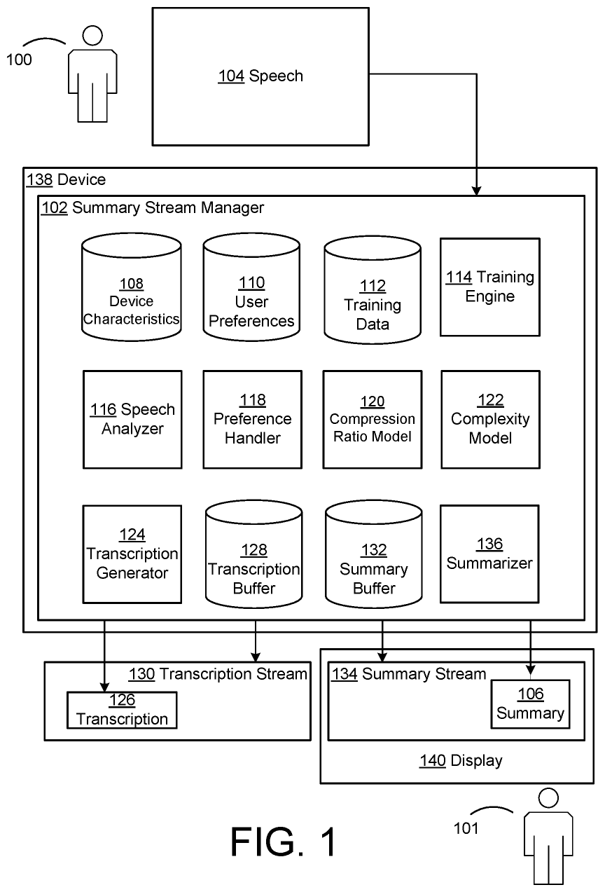

FIG. 1 is a block diagram of a system for dynamic summary adjustments for live summaries. In the example of FIG. 1, a summary stream manager 102 processes speech 104 (audio data, also referred to as spoken input) of a speaker 100 to obtain a summary 106 that is provided to a user 101 as part of a live, dynamically adjusted summary stream 134 (a data stream). As referenced above, the speech 104 may include virtually any spoken words or other spoken input. For example, the speech 104 may a lecture, a talk, a dialogue, an interview, a conversation, or any other spoken-word interaction of two or more participants. Such interactions may be largely one-sided (a monologue), such as in the case of a lecture, or may be an equal give-and-take between the speaker 100 and the user 101.

For example, a conversation may be conducted between the speaker 100 and the user 101, and the conversation may be facilitated by the summary stream manager 102. As just noted, in other examples, the speaker 100 may represent a lecturer, while the user 101 represents a lecture attendee, so that the summary stream manager 102 facilitates a utility of the lecture to the user 101. The speaker 100 and the user 101 may be co-located and conducting an in-person conversation, or may be remote from one another and communicating via web conference.

In other examples, the speaker 100 may record the speech 104 at a first time, and the user 101 may view (and receive the summary 106 of) the recorded audio and/or video at a later time. In this sense, the term ‘live conversation’ should be understood to be primarily from the perspective of the user 101. For example, as just noted, the user 101 may listen live to a video of the speaker 100 that was previously recorded, and be provided with the type of live, dynamically-adjusted summary stream 134 described herein.

FIG. 1 should thus be understood to illustrate an ability of the summary stream manager 102 to provide the summary 106 in a stand-alone or static manner, in response to a discrete instance of the speech 104 (e.g., summarizing audio of a single recorded video). At the same time, FIG. 1 also illustrates an ability of the summary stream manager 102 to receive speech of the speaker 100 over a first time interval and output the summary 106 to the user 101, and then to repeat such speech-to-summary operations over a second and subsequent time interval(s) to provide the types of dynamic summarizations referenced above, and described in detail below with reference to the summary stream 134. In other words, as shown and described, the summary 106 may be understood to represent a single discrete summary of corresponding discrete speech of the speaker 100 within a single time interval of a larger time period or time window of a conversation.

As also described in detail, below, the summary stream manager 102 may be implemented in conjunction with any suitable device 138, such as a handheld computing device, smartglasses, earbuds, or smartwatch. For example, the summary stream manager 102 may be implemented in conjunction with one or more such devices in which a microphone or other input device is used to receive the speech 104, and an audio output, visual display (e.g., a display 140 in FIG. 1), and/or other output device(s) is used to render or provide the summary 106 and the summary stream 134.

The summary stream manager 102 is illustrated in the simplified example of FIG. 1 as a single component that includes multiple sub-components. As also described below, however, the summary stream manager 102 may be implemented using multiple devices in communication with one another.

As shown in FIG. 1, the summary stream manager 102 may include or utilize device characteristics 108 of the one or more devices represented by the device 138 in FIG. 1, (e.g., characteristics its hardware and/or software). For example, device characteristics may include a display size of the display 140, available fonts or formats, or available scroll rates of the device 138/display 140.

User preferences 110 may include any user preference for receiving the summary stream 134 (e.g., as reflected by device settings chosen by a user or by other operation of the device by a user). For example, the user preferences 110 may include a user preference for a slow, medium, or fast scroll rate of the summary stream 134 on the display 140. The user preferences 110 may also specify preferred fonts/formats, or preferred device(s) among a plurality of available devices. The user preferences 110 may also include a preference of the user 101 for a complexity or style of the summary stream, such as basic, intermediate, or advanced. The user preferences 110 may be input manually by the user 101, and/or inferred by the summary stream manager 102 based on actions of the user 101.

Training data 112 generally represents any training data that may be processed by a training engine 114 to train one or more machine learning (ML) models, as described herein. The training data 112 may represent one or more available repositories of labelled training data used to train such ML models, and/or may represent training data compiled by a designer of the summary stream manager 102.

A speech analyzer 116 may be configured to receive the speech 104, e.g., via a microphone or other input of the device 138, and process the speech 104 to determine relevant speech characteristics (as reflected by the audio data representing the speech). For example, the speech analyzer 116 may calculate or otherwise determine a rate, a tonality, a volume, a pitch, an emphasis, or any other characteristic of the speech 104. The speech analyzer 116 also may identify the speaker 100 individually or as a class/type of speaker. For example, the speech analyzer 116 may identify the speaker 100 as a friend of the user 101, or as a work colleague or teacher of the user 101. The speech analyzer 116 may also identify a language being spoken by the speaker 100.

A preference handler 118 may be configured to receive or identify any of the user preferences 110 discussed above. As such, the preference handler 118 may provide for interactivity with the user 101, e.g., via the display 140, to receive manually-submitted preferences. In other examples, the preference handler 118 may represent a component, such as a trained ML model (e.g., trained using the training data 112 and the training engine 114), that is configured to analyze selections made or actions taken by the user 101 with respect to the summary stream 134, in order to determine or infer the user preferences 110. For example, the preference handler 118 may detect that the user 101 frequently rewinds the summary stream 134, and may update the user preferences 110 to reflect a slower scroll rate of the summary stream 134 going forward.

The training engine 114 may be configured to train and deploy a compression ratio model 120, using the training data 112. A compression ratio refers to a measure of an extent to which the summary 106 is reduced with respect to corresponding input speech of the speech 104. For example, in a simple example, if the summary 106 includes 50 words and is generated from speech 104 that includes 100 words, the corresponding compression ratio would be 50% or 0.5. A compression ratio may be calculated using various techniques in addition to, or instead of, word count. For example, a compression ratio may be expressed as a character count rather than a word count, or may be implemented as a word count but excluding stop words. In other examples, the compression ratio may be expressed as an extent to which output text data is reduced relative to input text data, or, in other words, as a percentage reduction in data quantity or volume.

As described in detail, below, the compression ratio model 120 may be configured to input relevant device characteristics of the device characteristics 108, relevant user preferences of the user preferences 110, and analyzed speech from the speech analyzer 116. The compression ratio model may then output a compression ratio for use in generating the summary 106 of the summary stream 134.

The training engine 114 may also be configured to train and deploy a complexity model 122, using the training data 112. The complexity model 122 may be configured to output a complexity metric that indicates whether the summary 106 should be generated with a basic, intermediate, or advanced language structure. For example, such complexity metrics may refer to a vocabulary level, and/or to a level of grammar or syntax of the summary 106.

In example implementations, one or more of the compression ratio model 120 and/or the complexity model 122 may be implemented as a classifier. A classifier refers generally to any trained model or algorithm that processes inputs to associate the inputs with at least one class of a plurality of pre-defined classes (of data). Classifiers may be implemented, for example, as a naïve Bayesian classifier, decision tree classifier, neural network/deep learning classifier, or support vector machine, or any suitable classifier or combination of classifiers.

For example, the compression ratio model 120 may be trained using known instances of training text (including, e.g., training speech and associated speech characteristics, training user preferences, and/or training device characteristics) that are each associated with a corresponding class label describing a type or extent of compression in a corresponding ground truth summary. Such class labels, and corresponding compression ratios, may correspond to canonical categories, such as small, medium, large. In other examples, the compression ratio may be categorized on a pre-defined scale, e.g., between 0 and 1, or as a percentage.

When errors occur between the generated compression ratio as compared to a ground truth compression ratio of the training data, a type and/or degree of the error may be used by the training engine 114 in a subsequent training iteration to adjust weights or other parameters of the compression ratio model 120. Over multiple iterations, the weights or other parameters may thus be adjusted by the training engine 114 to cause the compression ratio model 120, once deployed, to process the speech 104 and generate a corresponding compression ratio, with an acceptable level of accuracy.

Similarly, the complexity model 122 may be trained using known instances of training text (including, e.g., training speech and associated speech characteristics (including vocabulary, grammar, and syntax characteristics) and training user preferences) that are each associated with a corresponding class label describing a type or extent of complexity in a corresponding ground truth summary. Such class labels, and corresponding complexities, may correspond to canonical categories, such as basic, intermediate, complex, or beginner, proficient, fluent. In other examples, the complexity may be categorized on a pre-defined scale, e.g., between 0 and 1, or as a percentage.

When errors occur between the generated complexity as compared to a ground truth complexity of the training data, a type and/or degree of the error may be used by the training engine 114 in a subsequent training iteration to adjust weights or other parameters of the complexity model 122. Over multiple iterations, the weights or other parameters may thus be adjusted by the training engine 114 to cause the complexity model 122, once deployed, to process the speech 104 and generate a corresponding complexity, with an acceptable level of accuracy.

A transcription generator 124 may be configured to convert the spoken words of the speech 104 (audio data) to transcribed text (text data), shown in FIG. 1 as a transcription 126. For example, the transcription generator 124 may include an automatic speech recognition (ASR) engine or a speech-to-text (STT) engine.

The transcription generator 124 may include many different approaches to generating text, including additional processing of the generated text. For example, the transcription generator 124 may provide timestamps for generated text, a confidence level in generated text, and inferred punctuation of the generated text. For example, the transcription generator 124 may also utilize natural language understanding (NLU) and/or natural language processing (NLP) models, or related techniques, to identify semantic information (e.g., sentences or phrases), identify a topic, or otherwise provide metadata for the generated text.

The transcription generator 124 may provide various other types of information in conjunction with transcribed text, perhaps utilizing related hardware/software. For example, the transcription generator 124 may analyze an input audio stream to distinguish between different speakers, or to characterize a duration, pitch, speed, or volume of input audio, or other audio characteristics. For example, in some implementations, the transcription generator 124 may be understood to implement some or all of the speech analyzer 116.

In FIG. 1, the transcription generator 124 may utilize a transcription buffer 128 to output a transcription stream 130. That is, for example, the transcription generator 124 may process a live conversation, discussion, or other speech, in real time and while the speech is happening. The transcription 126 thus represents a transcription of a segment or instance of transcribed text within a time interval that occurs within a larger time period or time window of a conversation. For example, the summary 106 may represent a summarization of the transcription 126, where the transcription 126 represents a transcript of, e.g., a first 10 seconds of the speech

For example, while the speaker 100 is speaking, the transcription generator 124 may output transcribed text to be stored in the transcription buffer 128. The transcribed text may be designated as intermediate or final text within the transcription buffer 128, before being available as the transcription 126/transcription stream 130 (a data stream). For example, the transcription generator 124 may detect the end of a sentence, a switch in speakers, a pause of pre-defined length, or other detected audio characteristic to designate a final transcription to be included in the transcription stream 130. In other examples, the transcription generator 124 may wait until the end of a defined or detected time interval to designate a final transcription of audio.

The transcription stream 130 may thus be processed by a summarizer 136 to populate a summary buffer 132 and otherwise output the summary 106/summary stream 134 (a data stream). The summarizer 136 may represent any trained model or algorithm designed to perform summarization. For example, the summarizer 136 may be implemented as a sequence-to-sequence generative large learning model (LLM).

In example implementations, the compression ratio model 120, the complexity model 122, and the summarizer 136 may be trained independently, or may be trained together in groups of two or more. As referenced above, and described in more detail, below, training for each stage/model may be performed with respect to, e.g., input text representing examples of the (transcribed) speech 104, relevant training data labels, a generated output of the model being trained, a ground truth output of the model being trained, and/or a ground truth summary output of the summarizer 136. The generated output(s) may thus be compared to the ground truth output(s) to conduct back propagation and error minimization to improve the accuracy of the trained models.

Then, following completion of training and deployment of the compression ratio model 120, the complexity model 122, and the summarizer 124, current/detected user preferences, speech characteristics, and device characteristics may be processed by the compression ratio model 120 and/or the complexity model 122 to parameterize operations of the summarizer 136. For example, for the transcription 126, the summarizer 136 may be provided with a particular compression ratio and complexity level, and may output the summary 106 accordingly within the summary stream 134. For example, outputs of the compression ratio model 120 and/or the complexity model 122 may be provided as textual input(s) to the summarizer 136, e.g., may be concatenated and fed to the summarizer 136.

In example implementations, the summary stream manager 102 may be configured to manage various other characteristics of the summary stream 134, relative to, or in conjunction with, the transcription stream 130. For example, the stream manager 102 may utilize characteristics of the transcription stream 130 to determine whether or when to invoke the summarizer 136 to generate the summary 106. For example, the stream manager 102 may detect sentence endings, pauses in speech, or a rate (or other characteristic) of the audio to determine whether/when to invoke the summarizer 136.

In further examples, the stream manager 102 may be configured to control various display characteristics with which the transcription stream 130 and/or the summary stream 134 are provided. For example, the stream manager 102 may provide the user 101 with an option to view either or both (e.g., toggle between) the transcription stream 130 and the summary stream 134.

The stream manager 102 may also be configured to display various indicators related to the transcription stream 130 and the summary stream 134. For example, the stream manager 102 may display a summarization indicator that informs the user 101 that a current portion of the summary stream 134 is being generated, while the summarizer 136 is processing a corresponding portion of the transcription stream 130.

As referenced above, the stream manager 102 may also control a size, spacing, font, format, and/or speed (e.g., scrolling speed) of the transcription stream 130 and the summary stream 134. Additionally, the stream manager 102 may provide additional processing of the summary stream 134. For example, the stream manager 102 may identify and extract actionable content within the summary stream 134, such as calendar items, emails, or phone calls. In some implementations, the stream manager 102 may be configured to facilitate or enact corresponding actions, such as generating a calendar item, or sending an email or text message, based on content of the summary stream 134.

Although the transcription buffer 128 and the summary buffer 132 are described herein as memories used to provide short-term storage of, respectively, the transcription stream 130 and the summary stream 134, it will be appreciated that the same or other suitable memory may be used for longer-term storage of some or all of the transcription stream 130 and the summary stream 134. For example, the user 101 may wish to capture a summary of a lecture that the user 101 attends for later review. In these or similar situations, multiple instances or versions of the summary 106 may be provided, and the user 101 may be provided with an ability to select a most-desired summary for long term storage.

In FIG. 1, the transcription stream 130 is shown separately from the summary stream 134, and from the display 140. However, as noted above, the transcription stream 130 may be displayed on the display concurrently with, or instead of, the summary stream 134. Moreover, the transcription stream 130 and the summary stream 134 may be implemented as a single (e.g., interwoven) stream of captions. That is, for example, the transcription stream 130 may be displayed for a period of time, and then a summary request may be received via the input device 142, and a corresponding summary (e.g., the summary 106) may be generated and displayed. Put another way, an output stream of the display 140 may alternate between displaying the transcription stream 130 and the summary stream 134.

In the simplified example of the stream manager 102, the various sub-components 108-136 are each illustrated in the singular, but should be understood to represent at least one instance of each sub-component. For example, two or more training engines, represented by the training engine 114, may be used to implement the various types of training used to train and deploy the compression ratio model 120, the complexity model 122, and/or the summarizer 136.

Thus, any of the compression ratio model 120, the complexity model 122, and/or the summarizer 136 may be trained jointly. Additional or alternative implementations of the summary stream manager 102 are provided below, including additional or alternative training techniques.

In FIG. 1, the summary stream manager 102 is illustrated as being implemented and executed using a device 138. For example, the device 138 may represent a handheld computing device, such as a smartphone, or a wearable computing device, such as smartglasses, smart earbuds, or a smartwatch.

The device 138 may also represent cloud or network resources in communication with a local device, such as one or more of the devices just referenced. For example, the various types of training data and the training engine 114 may be implemented remotely from the user 101 operating a local device, while a remainder of the illustrated components of the summarization manager are implemented at one or more of the local devices.

The summary 106 and/or the summary stream 134 are illustrated as being output to a display 140. For example, the display 140 may be a display of the device 138, or may represent a display of a separate device(s) that is in communication with the device 138. For example, the device 138 may represent a smartphone, and the display 140 may be a display of the smartphone itself, or of smartglasses or a smartwatch worn by the user 101 and in wireless communication with the device 138.

In FIG. 1, the transcription stream 130 is shown separately from the summary stream 134, and from the display 140. However, as noted above, the transcription stream 130 may be displayed on the display concurrently with, or instead of, the summary stream 134. Moreover, the transcription stream 130 and the summary stream 134 may be implemented as a single (e.g., interwoven) stream of captions. That is, for example, the transcription stream 130 may be displayed for a period of time, and then a summary request may be received via the input device 142, and a corresponding summary (e.g., the summary 106) may be generated and displayed. Put another way, an output stream of the display 140 may alternate between displaying the transcription stream 130 and the summary stream 134.

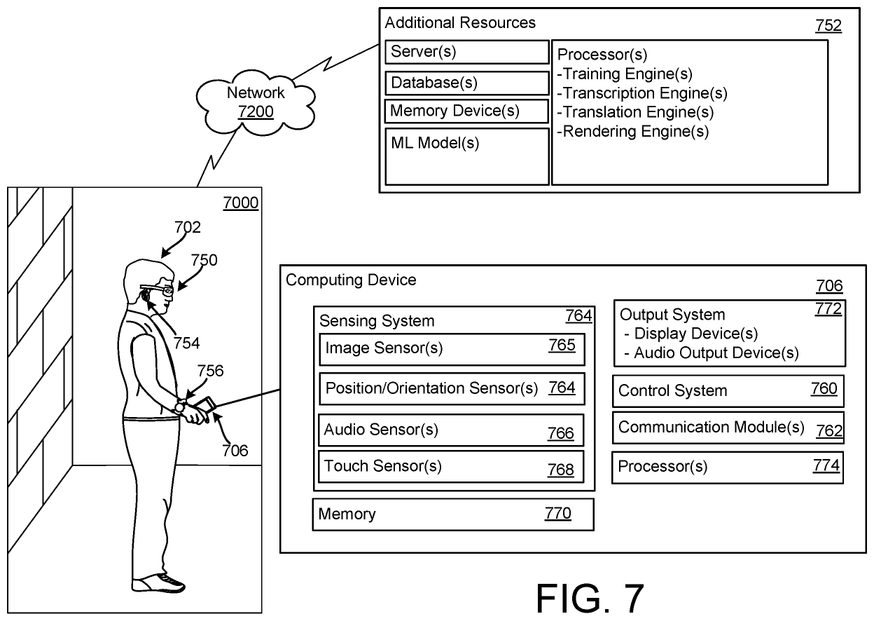

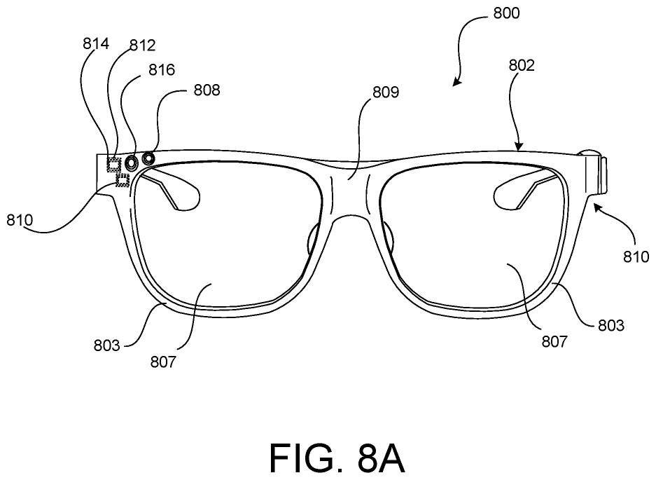

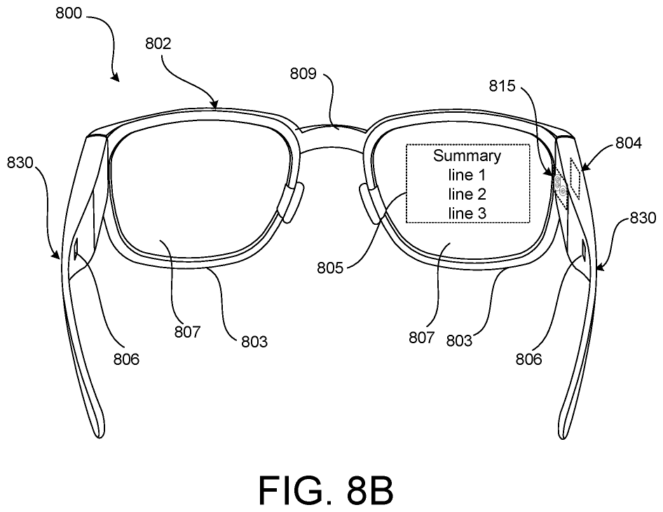

More detailed examples of devices, displays, and network architectures are provided below, e.g., with respect to FIGS. 7, 8A, and 8B. In addition, the summary 106 and the summary stream 134 (as well as the transcription 126 and the transcription stream 130) may be output via audio, e.g., using the types of smart earbuds referenced above.

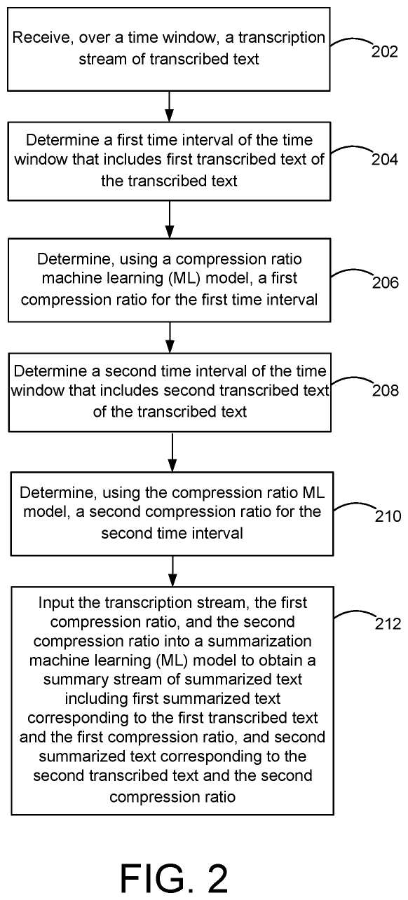

FIG. 2 is a flowchart illustrating example operations of the system of FIG. 1. In the example of FIG. 2, operations 202-212 are illustrated as separate, sequential operations. However, in various example implementations, the operations 202-212 may be implemented in a different order than illustrated, in an overlapping or parallel manner, and/or in a nested, iterative, looped, or branched fashion. Further, various operations or sub-operations may be included, omitted, or substituted.

In FIG. 2, a transcription stream of transcribed text (data stream) may be received over a time window (202). For example, the transcription stream 130 may be received from the transcription generator 124, providing a transcription of the speech 104 of the speaker 100.

A first time interval of the time window that includes first transcribed text of the transcribed text may be determined (204). For example, the summary stream manager 102 may determine a first time interval of a time window that includes the transcription 126, and for which the summary 106 will be generated. For example, during a time window of a conversation with, or a lecture by, the speaker 100, the first time interval may include a first quantity of speech 104, such as a certain number of words. The first time interval may be determined, e.g., by a pause in speaking by the speaker 100, or any suitable criteria, some examples of which are provided below. In other examples, the first time interval may simply be set as aa pre-defined time interval, such as 5 seconds, or 10 seconds. A time interval may also be defined based on speech content such as pauses or punctuation determined by the transcription generator 124. In other examples, the time interval(s) may be determined by manual actions or interactions with the user 101, such as when the user 101 uses a gesture-based input or other I/O method to initiate a summary from a transcription.

Using the compression ratio machine learning (ML) model 120, a first compression ratio for the first time interval may be determined (206). For example, the compression ratio model 120 may determine a first compression ratio based on the device characteristics 108, speech characteristics of the speaker 100 during the first time interval as determined by the speech analyzer 116, and/or on the user preferences 110 of the user 101, as determined by the preference handler 118.

A second time interval of the time window that includes second transcribed text of the transcribed text may be determined (208). For example, the second time interval may follow the first time interval and may be detected or determined using similar criteria use to determine the first time interval. For example, the transcription 126 may be captured during a first 5 seconds to generate the summary 106, and a second transcription of the transcription stream 130 may be captured during a subsequent 5 seconds to generate a second summary of the summary stream 134. In other examples, the time intervals may not be uniform. For example, the summary stream manager 102 may generate the summary 106 after a first pause by the speaker 100 that follows a first time interval of speaking, and may generate a subsequent summary of the summary stream 134 after a second pause by the speaker 100.

Using the compression ratio ML model 120, a second compression ratio for the second time interval may be determined (210). For example, the compression ratio model 120 may use analyzed speech from the speech analyzer 116 for the second time interval, along with device characteristics 108 and user preferences 110, to determine a second compression ratio.

The transcription stream, the first compression ratio, and the second compression ratio may be input into the summarization machine learning (ML) model 136 to obtain the summary stream 134 (a data stream) of summarized text including first summarized text corresponding to the first transcribed text and the first compression ratio, and second summarized text corresponding to the second transcribed text and the second compression ratio (212). For example, as referenced above, the summary stream 134 may include the summary 106 with a first compression ratio for the first time interval, and a second summary with a second compression ratio for the second time interval.

Thus, FIG. 2 illustrates that the summary stream manager 102 may be configured to provide dynamic adjustments of compression ratios within the summary stream 134 during a live conversation or other interaction between the speaker 100 and the user 101, and/or between other conversation participants. Consequently, the user 101 may receive summaries within the summary stream 134 that are sized optimally to enable the user 101 to consume the summaries in a desired manner (e.g., at a desired pace) that is optimized for display characteristics of the display 140.

Moreover, the summaries of the summary stream 134 will be optimized to capture important or desired information from the speech 104. For example, during a time interval in which the speaker 100 speaks with a higher volume or faster rate, the compression ratio may be raised, so that more of the speech information from that time interval is captured within a corresponding summary of the summary stream 134.

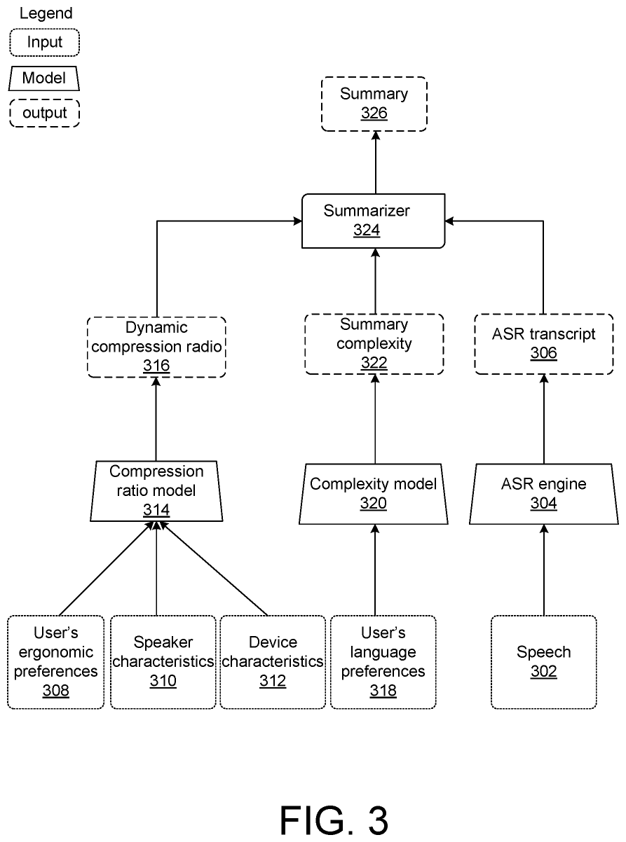

As noted above, additional or alternative operations of FIG. 2 may be included, as well. For example, the complexity model 122 may be used to cause the summarizer 136 to adjust a complexity of the summary 106 and other summaries within the summary stream 134, as described with respect to FIG. 1. For example, the user 101 may prefer a certain level of complexity (e.g., basic) with respect to speech from the speaker 100, such as when the speaker 100 is an expert in a subject and the user 101 desires a basic understanding of discussions with the speaker regarding the relevant subject. However, when the user 101 discusses a different subject with the speaker 100, or with another speaker, and the user 101 is an expert in the different subject, the user 101 may prefer a correspondingly different complexity level (e.g., complex, or fluent). As described below, e.g., with respect to FIG. 3, the complexity model 122 and the compression ratio model 120 may both be used to simultaneously input to, and parameterize, the summarizer 136.

FIG. 3 is a block diagram illustrating a more detailed example implementation of the system of FIG. 1. FIG. 3 illustrates an ability of described techniques to generate summaries dynamically tuned to ergonomic factors and other user preferences, as well as user capabilities. The user 101 and the device 138/140 are able to influence both the compactness and complexity of generated summaries. Additionally, described techniques are capable of tuning summaries based on the speech being transcribed, resulting in a fluid and comfortable experience for the user 101.

In FIG. 3, input speech 302 is received at an ASR engine 304 as an example of the transcription generator 124 of FIG. 1. The ASR engine 304 thus outputs an ASR transcript 306 as part of a larger transcription stream, corresponding to the transcription stream 130 of FIG. 1.

Further in FIG. 3, a user's ergonomic preferences 308 refer to an example of the user preferences 110 that relate to preferred settings or uses of the device 138 and/or the display 140 with respect to receiving the summary stream 134. For example, such user ergonomic preferences may refer to a speed (e.g., slow, medium, fast) of scrolling of the summary stream 134 on the display 140.

The user's ergonomic preferences 308 may thus include, e.g., a speed at which the user is able to read the text on their device comfortably, a rate at which the user is comfortable following the lines scrolling up a screen (e.g., the display 140 of FIG. 1), and a rate at which the user is comfortably able to follow incremental updates at the tail end of the summary displayed. The above and similar rates may be represented, e.g., as words/lines per minute or, as referenced above, canonically as slow, medium, or fast. The user's ergonomic preferences 308 may be manually entered, or may be inferred from other user settings, interactions with the device, or general behavior as observed by the preference handler 118 of FIG. 1. The user's ergonomic preferences 308 may be expressed in numeric form, e.g., a numeric range corresponding to a range of scroll speeds.

Speaker characteristics 310 refer generally to a manner(s) in which the speaker 100 provides the speech 104. A speed of elocution of the speaker 100, for instance, may be used to govern how detailed or terse the summaries should be to help the user 101 keep up with a conversation. Emotions of the speaker 100 may be captured through words chosen, and tonality of speech, and similar factors, and may be used to infer potentially important information to include in one or more summaries.

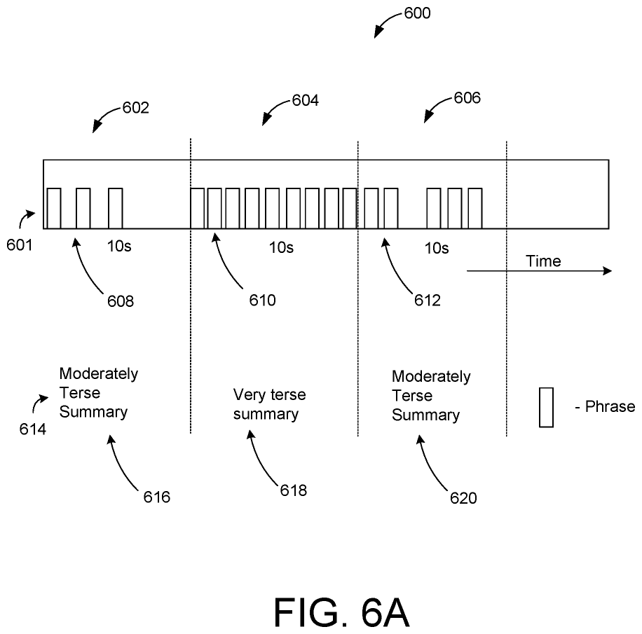

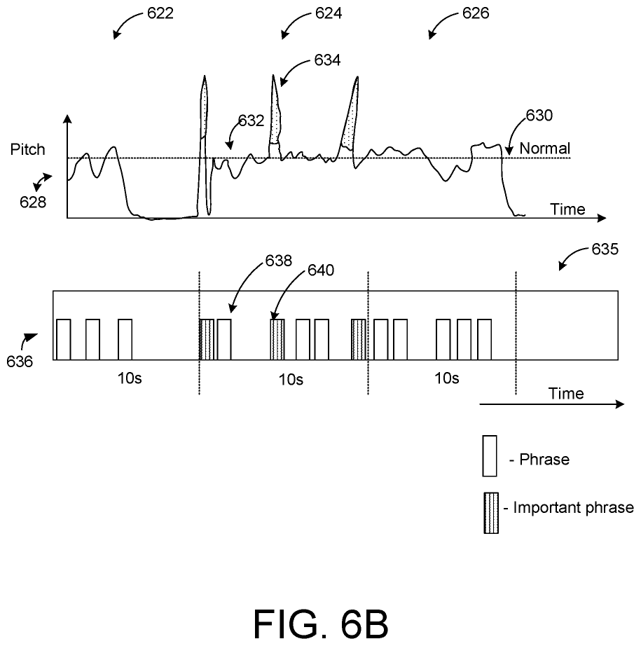

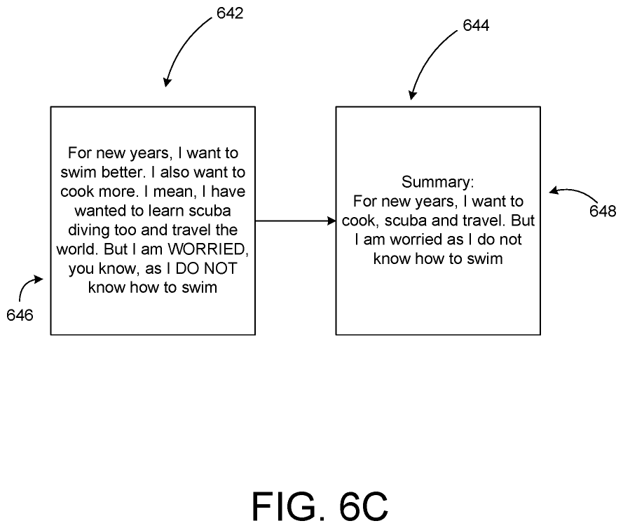

Speaker characteristics 310 may be detected by the speech analyzer 116 in each relevant time interval and may each be represented in numeric form. For example, a numeric range may be assigned to speech qualities such as speed, tonality, pitch, or volume. In other examples, a numeric value may be assigned to changes in the above or similar qualities/aspects, e.g., a degree to which a speech volume changes (lowers or raises) from time interval to time interval, or within a time interval. Additional examples are provided below, e.g., with respect to FIGS. 6A-6B.

Device characteristics 312 provide examples of the device characteristics 108 of FIG. 1. For example, the device characteristics 312 may include a layout of words on a screen, such as a number of words appearing in a single line, a number of lines appearing on the screen in one scroll, or similar metrics. The device characteristics 312 may be altered by the user 101 but are configured by the user 101 at the device level, whereas the ergonomic user's preferences 308 mentioned above relate to the preferences of the user 101 while consuming summaries. Similar to the user's ergonomic preferences 308 and the speaker characteristics 310, the device characteristics 312 may be represented numerically.

A compression ratio model 314 may be configured to input the user's ergonomic preferences 308, the speaker characteristics 310, and the device characteristics 312 and generate a dynamic compression ratio 316. For example, as described above with respect to FIGS. 1 and 2, and illustrated by way of additional examples below, the compression ratio model 314 may determine the dynamic compression ratio 316 for each of a plurality of time intervals that occur during a larger time window or time period, e.g., during a conversation between the speaker 100 and the user 101.

The dynamic compression ratio 316 thus represents a measure of information lost between a transcript and its corresponding summary. For example, the dynamic compression ratio 316 may be calculated by dividing a number of characters in a summary by a number of characters in a corresponding, original transcript/text.

Also in FIG. 3, user's language preferences 318, which may also be included in user preferences 110 of FIG. 1, may be characterized and quantified to be provided to a complexity model 320. The user's language preferences 318 may include, e.g., a linguistic style of summaries the user 101 is comfortable with. For example, a complexity of a sentence structure may be represented as simple, medium or complex, and an intensity of the vocabulary may be represented as foundational, practical, or fluent. The user's language preferences 318 may be manually entered or inferred from other user settings, interactions with the device, or general behavior as observed by the preference handler 118. In addition to the canonical categories just referenced, complexity measures for one or more of the above factors may be represented numerically.

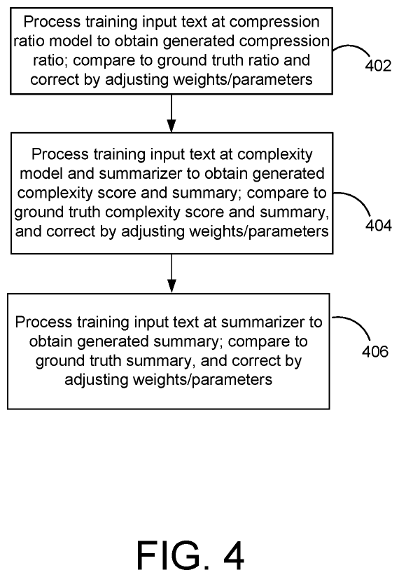

Accordingly, the complexity model 320 may be configured to output a summary complexity 322. For example, the summary complexity 322 may be represented by a score between 0 and 1, with higher values representing a relative comfort of the user 101 with more complex transcripts. In other examples, an N-dimensional numeric vector representation of the summary complexity 322 may be used. N-dimensional numeric representations, when the complexity model 320 is implemented as a deep neural network, derives the representation of the summary complexity 322 from an N-dimensional hyperspace such that the resulting N-dimensional vector is capable of encouraging a summarizer 324, corresponding to the summarizer 136 of FIG. 1, to produce summaries having the desired level of complexity. Further details relating to using such N-dimensional vectors, and otherwise relating to training the compression ratio model 314, the complexity model 320, and the summarizer 324, are described below, e.g., with respect to FIG. 4.

Thus, the architecture of FIG. 3 enables use of the various inputs referenced above to model the dynamic compression ratio 316 and the summary complexity 322, and to thus enable the summarizer 324 to output a highly customized and optimized summary 326. For example, the summarizer 324 may be implemented as a sequence-to-sequence (seq-to-seq) generation model.

Described techniques provide fluid, dynamic, real-time summaries, potentially across multiple scenarios, situations, or other contexts that may occur consecutively or in succession. For example, a student may attend a lecture of a professor, the professor may finish the lecture and provide instructions for out-of-class work, and the student may then have a conversation with the professor. Within and among these different scenarios, the architecture of FIG. 3 may provide a summary stream of summaries that are dynamically adjusted over a relevant time window(s).

FIG. 4 is a flowchart illustrating example training techniques for the example of FIG. 3. In the example of FIG. 4, training input text may be processed at the compression ratio model 314 to obtain a generated compression ratio, which may be compared to a known, ground truth compression ratio to enable adjustments and other corrections of weights/parameters of the compression ratio model 314 (402). For example, the training engine 114 of FIG. 1 may utilize the training data 112 when training the compression ratio model 314 as an example of the compression ratio model 120.

For example, the training data 112 may include many different types of transcriptions/texts, each labeled with a corresponding ergonomic preference(s), speaker/speech characteristic(s), and device characteristic(s). Each such instance (e.g., data record) of training data may also be associated with a ground truth compression ratio, such as 0.5, or 50%. Then, during training, the compression ratio model 314 may initially and incorrectly output a compression ratio of 0.8, or 80%. Back propagation and error minimization techniques may be used to adjust weights/parameters of the compression ratio model 314 to make it more likely that a next iteration of training will result in a correct (or at least a less wrong) compression ratio by the compression ratio model 314. Over many such iterations, the compression ratio model 314 will become more and more accurate at determining correct or optimal compression ratios.

Further in FIG. 4, training input text may be processed at the complexity model 320 and the summarizer 324 to obtain a generated complexity score and summary, which may be compared to a known, ground truth complexity score and summary to enable adjustments and other corrections of weights/parameters of the complexity model 320 and of the summarizer 324 (404). In other words, in the example of FIG. 4, the complexity model 320 and the summarizer 324 may be trained jointly, rather than independently. In this way, for example, the complexity model 320 may be trained to determine complexity scores along a sliding scale or as an N-dimensional vector, as referenced above.

In more detail, the summary complexity 322 may be represented as an N-dimensional vector with a set of, e.g., 10 numbers, which may not initially have any objective, assigned meaning. The complexity model 320 and the summarizer 324 may then be jointly trained as just described, in order to learn/assign meaning to the 10 dimensions of the N-dimensional vector. That is, as just described, complexity model 320 and the summarizer 324 may be provided with good and bad examples of scored complexity, and adjusting weights/parameters of complexity model 320 and the summarizer 324 to train complexity model 320 and the summarizer 324 to emulate the good examples/training data.

For example, conceptually, an N-dimensional vector output by the complexity model 320 for a specific word, e.g., “hotel” may be trained to be similar to an N-dimensional vector of the summarizer 324 that represents a similar word, e.g., “motel.” That is, the two vectors representing the two words will be close within the hyperspace in which the N-dimensional vectors exist. Similarly, N-dimensional vectors may be determined by/for complexity model 320 and the summarizer 324, where the N-dimensional vectors represent complexity scores. Consequently, by training the complexity model 320 and the summarizer 324 together as described, the complexity model 320 will generate complexity scores (e.g., as N-dimensional vectors) in a manner that will be meaningful to, and usable by, the summarizer 324. Specifically, during training, the summarizer 324 and the complexity model 320 may use back propagation to communicate whether a vector or score provided by the complexity model 320 resulting in a generated summary that was close/similar to a ground truth summary.

Finally in FIG. 4, training input text may be processed at the summarizer 324 to obtain a generated summary, which may be compared to a known, ground truth summary to enable adjustments and other corrections of weights/parameters of the summarizer (406). For example, for the example of FIG. 3, training data may include training compression ratio(s) 316 and training summary complexities 322, and the summarizer 324 may generate a summary to be compared against a corresponding ground truth summary.

In alternative example implementations, both the compression ratio model 314 and the complexity model 320 may be trained together with the summarizer 324 to produce desired summaries. In alternative examples, all of the compression ratio model 314, the complexity model 320, and the summarizer 324 may be implemented as a single model, with all inputs concatenated together for summaries to be generated based thereon.

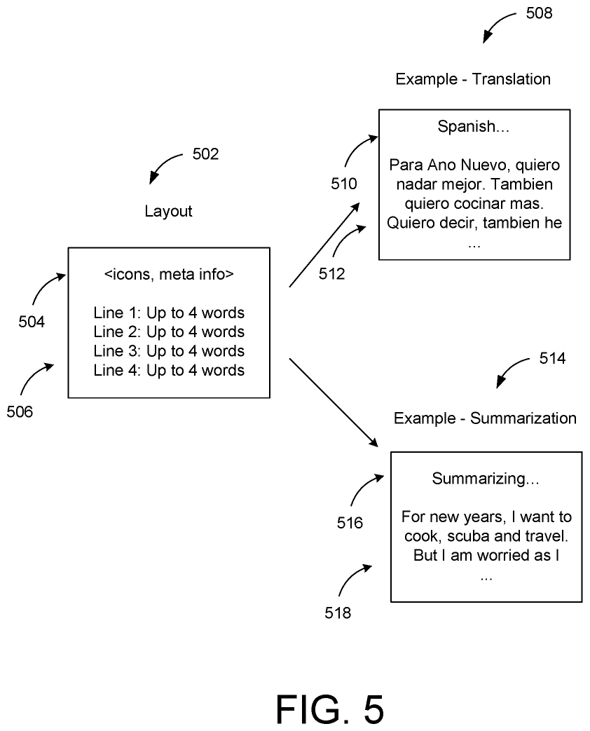

FIG. 5 illustrates example display layouts for use in the example of FIGS. 3 and 4. In the example of FIG. 5, a layout template 502 includes a header portion 504 and a body portion 506. As shown, the header portion 504 may be used to display one or more icons and/or related meta information or metadata, while the body portion 506 may include a specified number of lines (e.g., lines 1-4), each with a specified number of words (e.g., 4 words each), which are available, e.g., to scroll through the summary stream 134 of FIG. 1.

The layout template 502 may be constrained or otherwise defined using one or more of the device characteristics 108 and/or the user preferences 110 in FIG. 1 (e.g., the user's ergonomic preferences 308 in FIG. 3). For example, the device characteristics 108 may specify maximum values of, e.g., number of lines and/or number of words per line, which may directly or indirectly impact other parameters, such as font size. The device characteristics 108 may also specify a minimum or maximum scroll rate of the layout template 502, along with any other display parameters and associated minimum, maximum, or optimal value(s).

The user's ergonomic preferences 308 may thus specify preferred values of the user 101 within the constraints of the device characteristics 108. For example, the user's ergonomic preferences 308 may specify fewer than four lines in the layout template 502, or fewer than 4 words per line (e.g., so that a size of each word may be larger than in the example of FIG. 5.). The user's ergonomic preferences 308 may also specify a scroll rate experienced by the user 101, where the scroll rate may be designated as slow/medium/fast (or between values ranging between 0 and 1) defined relative to minimum/maximum available scroll rates of a relevant device/display.

The header 504 may include virtually any information that may be useful to the user 101 in interpreting, understanding, or otherwise using the summary stream provided in the layout body 506. For example, as shown in an example layout 508, a header 510 indicates that a body portion 512 is being rendered in Spanish, and in conformance with body portion 506 of the layout template 502.

In a further example layout 514, a header 516 indicates that summarization operations are processing and/or have been processed. For example, in addition to indicating that summarization is being performed, there may be a delay associated with inputting the transcription 126 and outputting the summary 106, and the header 516 may be useful in conveying a corresponding summarization status to the user 101, until a summary is ready to be included within a body portion 518.

FIG. 6A is a timing diagram illustrating example speech rates with corresponding summaries that are generated using the example of FIGS. 3 and 4. FIG. 6A illustrates that, within a time period or time window 600, a transcription stream 601 may include a first time interval 602, a second time interval 604, and a third time interval 606.

In the example, each of the time intervals 602, 604, 606 is ten seconds in duration, and includes a corresponding number of words/phrases 608, 610, and 612, respectively. As shown, there are three words/phrases 608 in the first time interval 602, nine words/phrases 610 in the second time interval 604, and five words/phrases 612 in the third time interval 606.

FIG. 6A may be understood to illustrate example operations of the speech analyzer 116 in determining examples of the speaker characteristics 310 of FIG. 3. Specifically, FIG. 6A may be understood to represent a determined speech rate of the speaker 100, which can be measured in phrases per time interval, or other suitable metric.

Then, as described above, a summary stream 614, corresponding to the summary stream 134, may be generated. In the time interval 602 a first compression ratio (e.g., 4, or 40%) may be determined by the compression model 314, providing a moderately terse summary 616. In the time interval 604 a second compression ratio (e.g., 0.8, or 80%) may be determined by the compression model 314, providing a very terse summary 618. In other words, because the speech rate of the speaker 100 in the time interval 604 is very fast, a higher compression ratio is needed in order to stay within user preference parameters, e.g., for the types of maximum summary quantities described with respect to FIG. 5 (such as words per line, or total number of lines). In the time interval 606 a third compression ratio (e.g., 0.5, or 50%) may be determined by the compression model 314, providing a moderately terse summary 620.

FIG. 6A illustrates that, when conversing with a speaker who speaks very fast, a very concise synopsis of the conversation may be useful in understanding the speaker, with less cognitive load required to keep up with the conversation. Thus, while summarization is a useful technique that aims to reduce the verbosity of transcripts without meaningfully reducing information content of the transcripts, conventional summarization models learn to produce terse transcripts without consideration of the ergonomics of presenting, or ease of comprehending, the summarized transcript. In contrast, described techniques are able to consider ergonomics and readability in delivering summary and translation solutions that are both usable and useful.

FIG. 6B is a timing diagram illustrating example speech changes and corresponding phrasing treatments using the example of FIGS. 3 and 4. In FIG. 6B, similar to FIG. 6A, a first time interval 622, a second time interval 624, and a third time interval 626 are illustrated.

A first diagram 628 illustrates a pitch of speech of the speaker 100 over time, and relative to a normal pitch 630. For example, the normal pitch 630 may be determined as an average for the individual speaker 100 over a preceding or current time window, or may be determined as a default value across multiple speakers and/or multiple conversation scenarios. Then, within the second time interval as an example, speech 632 may have approximately a normal pitch, while speech 634 is illustrated as having a higher than normal pitch.

A second diagram 635 illustrates transcribed word/phrases within the time intervals 622, 624, 626, and within a transcription stream 636. As shown, a word/phrase 638 corresponds to a level of normal speech 632, while a word/phrase 640 corresponds to a level of speech 634 that has a higher pitch (and/or volume, and/or tone). FIG. 6B thus illustrates that described techniques are capable of determining when a speaker expresses the importance of certain words/phrases through the tonality of the speech (for instance, emphasizing words/phrases 634/640 with higher volume). Consequently, the compression ratio model 314 and/or the complexity model 320 may enable the summarizer 324 to update a corresponding summary accordingly, as shown in more detail in FIG. 6C, as opposed to treating all words/phrases/sentences equally when summarizing.

FIG. 6C illustrates screenshots of an example summary generated using the timing diagrams of FIG. 6B. As shown, a first screenshot 642 includes a transcript “For New Years, I want to swim better. I also want to cook more. I mean, I have wanted to learn scuba diving too and travel the world. But I am worried, you know, as I do not know how to swim.” In FIG. 6C, an emphasized portion 646 of the transcript 642 is illustrated as “I am WORRIED, you know, as I DO NOT know how to swim.”

As described with respect to FIG. 6B, the emphasized portion 646 may be detected based on differences in pitch, tone, or volume of the detected speech of the speaker 100. Then, within a second screenshot 644, a summary 648 includes the emphasized portion 646 with a very low compression ratio, removing only the phrase, “you know”, while a remainder of the transcript of the screenshot 642 is compressed at a might higher ratio.

FIGS. 6A-6C primarily provide examples of operations of the compression ratio model 314 (or the compression ratio model 120). In other examples, the user 101 may prefer simpler sentences and a more basic vocabulary, and the complexity model 320 may cause the summarizer 324 to produce a summary 326 that avoids complex sentence formations or words that are used in more advanced or domain-specific context.

Thus, described example techniques enable modeling user preferences, device characteristics, and speech characteristics into intermediate representations, and then using such intermediate representations as additional inputs along with a raw ASR transcript to produce useful and usable summaries. Described techniques enable dynamically controlling summarization to be more or less terse, and more or less complex, based at least on the aforementioned factors, or similar suitable factors.

FIG. 7 is a third person view of a user 702 (analogous to the user 101 of FIG. 1) in an ambient environment 7000, with one or more external computing systems shown as additional resources 752 that are accessible to the user 702 via a network 7200. FIG. 7 illustrates numerous different wearable devices that are operable by the user 702 on one or more body parts of the user 702, including a first wearable device 750 in the form of glasses worn on the head of the user, a second wearable device 754 in the form of ear buds worn in one or both ears of the user 702, a third wearable device 756 in the form of a watch worn on the wrist of the user, and a computing device 706 held by the user 702. In FIG. 7, the computing device 706 is illustrated as a handheld computing device, but may also be understood to represent any personal computing device, such as a table or personal computer.

In some examples, the first wearable device 750 is in the form of a pair of smart glasses including, for example, a display, one or more images sensors that can capture images of the ambient environment, audio input/output devices, user input capability, computing/processing capability and the like. Additional examples of the first wearable device 750 are provided below, with respect to FIGS. 8A and 8B.

In some examples, the second wearable device 754 is in the form of an ear worn computing device such as headphones, or earbuds, that can include audio input/output capability, an image sensor that can capture images of the ambient environment 7000, computing/processing capability, user input capability and the like. In some examples, the third wearable device 756 is in the form of a smart watch or smart band that includes, for example, a display, an image sensor that can capture images of the ambient environment, audio input/output capability, computing/processing capability, user input capability and the like. In some examples, the handheld computing device 706 can include a display, one or more image sensors that can capture images of the ambient environment, audio input/output capability, computing/processing capability, user input capability, and the like, such as in a smartphone. In some examples, the example wearable devices 750, 754, 756 and the example handheld computing device 706 can communicate with each other and/or with external computing system(s) 752 to exchange information, to receive and transmit input and/or output, and the like. The principles to be described herein may be applied to other types of wearable devices not specifically shown in FIG. 7 or described herein.

The user 702 may choose to use any one or more of the devices 706, 750, 754, or 756, perhaps in conjunction with the external resources 752, to implement any of the implementations described above with respect to FIGS. 1-6C. For example, the user 702 may use an application executing on the device 706 and/or the smartglasses 750 to receive, transcribe, and display the transcription stream 130 of FIG. 1 and/or the summary stream 134 of FIG. 1.

As referenced above, the device 706 may access the additional resources 752 to facilitate the various summarization techniques described herein, or related techniques. In some examples, the additional resources 752 may be partially or completely available locally on the device 706. In some examples, some of the additional resources 752 may be available locally on the device 706, and some of the additional resources 752 may be available to the device 706 via the network 7200. As shown, the additional resources 752 may include, for example, server computer systems, processors, databases, memory storage, and the like. In some examples, the processor(s) may include training engine(s), transcription engine(s), translation engine(s), rendering engine(s), and other such processors. In some examples, the additional resources may include ML model(s), such as the various ML models of the architectures of FIGS. 1 and/or 3.

The device 706 may operate under the control of a control system 760. The device 706 can communicate with one or more external devices, either directly (via wired and/or wireless communication), or via the network 7200. In some examples, the one or more external devices may include various ones of the illustrated wearable computing devices 750, 754, 756, another mobile computing device similar to the device 706, and the like. In some implementations, the device 706 includes a communication module 762 to facilitate external communication. In some implementations, the device 706 includes a sensing system 764 including various sensing system components. The sensing system components may include, for example, one or more image sensors 765, one or more position/orientation sensor(s) 764 (including for example, an inertial measurement unit, an accelerometer, a gyroscope, a magnetometer and other such sensors), one or more audio sensors 766 that can detect audio input, one or more touch input sensors 768 that can detect touch inputs, and other such sensors. The device 706 can include more, or fewer, sensing devices and/or combinations of sensing devices.

Captured still and/or moving images may be displayed by a display device of an output system 772, and/or transmitted externally via a communication module 762 and the network 7200, and/or stored in a memory 770 of the device 706. The device 706 may include one or more processor(s) 774. The processors 774 may include various modules or engines configured to perform various functions. In some examples, the processor(s) 774 may include, e.g, training engine(s), transcription engine(s), translation engine(s), rendering engine(s), and other such processors. The processor(s) 774 may be formed in a substrate configured to execute one or more machine executable instructions or pieces of software, firmware, or a combination thereof. The processor(s) 774 can be semiconductor-based including semiconductor material that can perform digital logic. The memory 770 may include any type of storage device or non-transitory computer-readable storage medium that stores information in a format that can be read and/or executed by the processor(s) 774. The memory 770 may store applications and modules that, when executed by the processor(s) 774, perform certain operations. In some examples, the applications and modules may be stored in an external storage device and loaded into the memory 770.

Although not shown separately in FIG. 7, it will be appreciated that the various resources of the computing device 706 may be implemented in whole or in part within one or more of various wearable devices, including the illustrated smartglasses 750, earbuds 754, and smartwatch 756, which may be in communication with one another to provide the various features and functions described herein. For example, the memory 770 may be used to implement the transcription buffer 128 and the summary buffer 132.

In FIG. 7, any audio and/or video output may be used to provide the types of summaries described herein, and associated features. For example, described techniques may be implemented in any product in which improving speech-to-text would be helpful and in which high-quality summaries would be beneficial. Beyond head-worn displays, wearables, and mobile devices, described techniques may be used in remote conferencing and web apps (including, e.g., providing captions/summaries within webconferencing software and/or pre-recorded videos).

Described techniques may also be useful in conjunction with translation capabilities, e.g., of the additional resources 752. For example, the user 702 may listen to a conversation from a separate speaker (corresponding to the speaker 100 of FIG. 1), who may be proximate to, or removed from, the user 702), where the speaker may be speaking in a first language. A translation engine of the processors of the additional resources 752 may provide automated translation of the dialogue into a native language of the user 702, and also may summarize the translated dialogue using techniques described herein.

The architecture of FIG. 7 may be used to implement or access one or more large language models (LLMs), which may be used to implement a summarizer for use in the preceding examples. For example, the Pathways Language Model (PaLM) and/or the Language Model for Dialogue Application (LaMDA), both provided by Google, Inc., may be used.

An example head mounted wearable device 800 in the form of a pair of smart glasses is shown in FIGS. 8A and 8B, for purposes of discussion and illustration. The example head mounted wearable device 800 includes a frame 802 having rim portions 803 surrounding glass portion, or lenses 807, and arm portions 830 coupled to a respective rim portion 803. In some examples, the lenses 807 may be corrective/prescription lenses. In some examples, the lenses 807 may be glass portions that do not necessarily incorporate corrective/prescription parameters. A bridge portion 809 may connect the rim portions 803 of the frame 802. In the example shown in FIGS. 8A and 8B, the wearable device 800 is in the form of a pair of smart glasses, or augmented reality glasses, simply for purposes of discussion and illustration.

In some examples, the wearable device 800 includes a display device 804 that can output visual content, for example, at an output coupler providing a visual display area 805, so that the visual content is visible to the user. In the example shown in FIGS. 8A and 8B, the display device 804 is provided in one of the two arm portions 830, simply for purposes of discussion and illustration. Display devices 804 may be provided in each of the two arm portions 830 to provide for binocular output of content. In some examples, the display device 804 may be a see through near eye display. In some examples, the display device 804 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 807, next to content (for example, digital images, user interface elements, virtual content, and the like) output by the display device 804. In some implementations, waveguide optics may be used to depict content on the display device 804.

The example wearable device 800, in the form of smart glasses as shown in FIGS. 8A and 8B, includes one or more of an audio output device 806 (such as, for example, one or more speakers), an illumination device 808, a sensing system 810, a control system 812, at least one processor 814, and an outward facing image sensor 816 (for example, a camera). In some examples, the sensing system 810 may include various sensing devices and the control system 812 may include various control system devices including, for example, the at least one processor 814 operably coupled to the components of the control system 812. In some examples, the control system 812 may include a communication module providing for communication and exchange of information between the wearable device 800 and other external devices. In some examples, the head mounted wearable device 800 includes a gaze tracking device 815 to detect and track eye gaze direction and movement. Data captured by the gaze tracking device 815 may be processed to detect and track gaze direction and movement as a user input. In the example shown in FIGS. 8A and 8B, the gaze tracking device 815 is provided in one of two arm portions 830, simply for purposes of discussion and illustration. In the example arrangement shown in FIGS. 8A and 8B, the gaze tracking device 815 is provided in the same arm portion 830 as the display device 804, so that user eye gaze can be tracked not only with respect to objects in the physical environment, but also with respect to the content output for display by the display device 804. In some examples, gaze tracking devices 815 may be provided in each of the two arm portions 830 to provide for gaze tracking of each of the two eyes of the user. In some examples, display devices 804 may be provided in each of the two arm portions 830 to provide for binocular display of visual content.

The wearable device 800 is illustrated as glasses, such as smartglasses, augmented reality (AR) glasses, or virtual reality (VR) glasses. More generally, the wearable device 800 may represent any head-mounted device (HMD), including, e.g., a hat, helmet, or headband. Even more generally, the wearable device 800 and the computing device 706 may represent any wearable device(s), handheld computing device(s), or combinations thereof.

Use of the wearable device 800, and similar wearable or handheld devices such as those shown in FIG. 7, enables useful and convenient use case scenarios of implementations of the systems of FIGS. 1-4. For example, such wearable and handheld devices may be highly portable and therefore available to the user 702 in many different scenarios. At the same time, available display areas of such devices may be limited. For example, the display area 805 of the wearable device 800 may be a relatively small display area, constrained by an overall size and form factor of the wearable device 800.

Consequently, the user 702 may benefit from use of the various summarization techniques described herein. For example, the user 702 may engage in interactions with separate speakers, such as a lecturer or a participant in a conversation. The user 702 and the separate speaker may have varying degrees of interactivity or back-and-forth, and two or more additional speakers may be present, as well.

Using described techniques, the user 702 may be provided with dynamic, real-time summarizations during all such interactions, as the interactions are happening. For example, the speaker may speak for a short time or a longer time, in conjunction with (e.g., in response to) dialogue provided by the user 702. During all such interactions, the user 702 may be provided with useful and convenient summaries of words spoken by the separate speaker(s).

As described, the dynamic, real-time summarizations may be provided with dynamically-updated compression ratios and complexities, or may otherwise be dynamically adjusted over time and during the course of a conversation or other interaction. As a result, the user 101/702 may be provided with meaningful, situation-specific summaries that reduce a cognitive load of the user 101/702 and facilitate meaningful interactions, even when one or more participants in the interaction(s) is not a native speaker, or is currently speaking a different language, or is an expert in a field speaking to a novice in the field.

A first example implementation, referred to here as example 1, includes a computer program product, the computer program product being tangibly embodied on a non-transitory computer-readable storage medium and comprising instructions that, when executed by at least one computing device, are configured to cause the at least one computing device to:

receive, over a time window, a transcription stream of transcribed text;

determine a first time interval of the time window that includes first transcribed text of the transcribed text;

determine, using a compression ratio machine learning (ML) model, a first compression ratio for the first time interval;

determine a second time interval of the time window that includes second transcribed text of the transcribed text;

determine, using the compression ratio ML model, a second compression ratio for the second time interval; and

input the transcription stream, the first compression ratio, and the second compression ratio into a summarization machine learning (ML) model to obtain a summary stream of summarized text including first summarized text corresponding to the first transcribed text and the first compression ratio, and second summarized text corresponding to the second transcribed text and the second compression ratio.

Example 2 includes the computer program product of example 1, wherein the instructions, when executed by the at least one computing device, are further configured to cause the at least one computing device to:

determine the first time interval and the second time interval as each including a pre-defined number of seconds.

Example 3 includes the computer program product of example 1 or 2, wherein the instructions, when executed by the at least one computing device, are further configured to cause the at least one computing device to:

determine the first time interval and the second time interval based on content of speech from which the transcribed text is transcribed.

Example 4 includes the computer program product of any one of the preceding examples, wherein the instructions, when executed by the at least one computing device, are further configured to cause the at least one computing device to:

determine at least one user preference for output of the summary stream; and

input the at least one user preference to the compression ratio ML model.

Example 5 includes the computer program product of example 4, wherein the at least one user preference includes a rate at which the first summarized text and the second summarized text are output.

Example 6 includes the computer program product of any one of the preceding examples, wherein the instructions, when executed by the at least one computing device, are further configured to cause the at least one computing device to:

determine at least one device characteristic of a device used to output the summary stream; and

input the at least one device characteristic to the compression ratio ML model.

Example 7 includes the computer program product of any one of the preceding examples, wherein the instructions, when executed by the at least one computing device, are further configured to cause the at least one computing device to:

determine at least one speech characteristic of speech from which the transcribed text is transcribed; and

input the at least one speech characteristic to the compression ratio ML model.

Example 8 includes the computer program product of example 7, wherein the at least one speech characteristic includes one or more of a rate of the speech, a volume of the speech, and a pitch of the speech.

Example 9 includes the computer program product of any one of the preceding examples, wherein the instructions, when executed by the at least one computing device, are further configured to cause the at least one computing device to:

determine, using a complexity ML model, a first complexity score for the first time interval;

determine, using the complexity ML model, a second complexity score for the second time interval; and

input the first complexity score and the second complexity score into the summarization ML model to obtain the summary stream including the first summarized text corresponding to the first transcribed text, the first compression ratio, and the first complexity score, and the second summarized text corresponding to the second transcribed text, the second compression ratio, and the second complexity score.

Example 10 includes the computer program product of example 9, wherein the instructions, when executed by the at least one computing device, are further configured to cause the at least one computing device to:

determine at least one user preference for a complexity level of the summary stream; and

input the at least one user preference to the complexity ML model.

In an eleventh example, referred to herein as example 11, a device includes:

at least one processor;

at least one memory;

at least one display; and

a rendering engine including instructions stored using the at least one memory, which, when executed by the at least one processor, cause the device to

render a summary stream on the at least one display that includes first summarized text of first transcribed text of a first time interval of a transcription stream, and second summarized text of second transcribed text of a second time interval of the transcription stream,

wherein the first summarized text has a first compression ratio relative to the first transcribed text that is determined by a compression ratio machine learning (ML) model, and the second summarized text has a second compression ratio relative to the second transcribed text that is determined by the compression ratio ML model.

Example 12 includes the device of example 11, wherein the rendering engine, when executed by the at least one processor, is further configured to cause the device to:

determine at least one user preference for output of the summary stream; and

input the at least one user preference to the compression ratio ML model.

Example 13 includes the device of example 11 or 12, wherein the rendering engine, when executed by the at least one processor, is further configured to cause the device to:

determine at least one device characteristic of a device used to output the summary stream; and

input the at least one device characteristic to the compression ratio ML model.

Example 14 includes the device of any one of examples 11 to 13, wherein the rendering engine, when executed by the at least one processor, is further configured to cause the device to:

determine at least one speech characteristic of speech from which the transcribed text is transcribed; and

input the at least one speech characteristic to the compression ratio ML model.

Example 15 includes the device of any one of examples 11 to 14, wherein the rendering engine, when executed by the at least one processor, is further configured to cause the device to:

determine, using a complexity ML model, a first complexity score for the first time interval;

determine, using the complexity ML model, a second complexity score for the second time interval; and

input the first complexity score and the second complexity score into the summarization ML model to obtain the summary stream including the first summarized text corresponding to the first transcribed text, the first compression ratio, and the first complexity score, and the second summarized text corresponding to the second transcribed text, the second compression ratio, and the second complexity score.

Example 16 includes the device of example 15, wherein the rendering engine, when executed by the at least one processor, is further configured to cause the device to:

determine at least one user preference for a complexity level of the summary stream; and

input the at least one user preference to the complexity ML model.

In a seventeenth example, referred to herein as example 17, a method includes:

receiving a transcription stream of transcribed text;

processing the transcribed text using a compression ratio machine learning (ML) model to determine at least two compression ratios; and

summarizing the transcribed text using the at least two compression ratios to obtain a summary stream that includes first summarized text having a first compression ratio of the at least two compression ratios, relative to a first corresponding portion of the transcribed text, and second summarized text having a second compression ratio of the at least two compression ratios, relative to a second corresponding portion of the transcribed text.

Example 18 includes the method of example 17, further comprising:

determining at least one user preference for output of the summary stream; and

inputting the at least one user preference to the compression ratio ML model.

Example 19 includes the method of example 17 or 18, further comprising:

determining at least one speech characteristic of speech from which the transcribed text is transcribed; and

inputting the at least one speech characteristic to the compression ratio ML model.

Example 20 includes the method of any one of examples 17 to 19, further comprising:

determining, using a complexity ML model, a first complexity score for the first corresponding portion of the transcribed text;

determining, using the complexity ML model, a second complexity score for the second corresponding portion of the transcribed text; and

inputting the first complexity score and the second complexity score into the summarization ML model to obtain the summary stream including the first summarized text corresponding to the first transcribed text, the first compression ratio, and the first complexity score, and the second summarized text corresponding to the second transcribed text, the second compression ratio, and the second complexity score.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

In some implementations, one or more input devices in addition to the computing device (e.g., a mouse, a keyboard) can be rendered in a display of an HMD, such as the HMD 800. The rendered input devices (e.g., the rendered mouse, the rendered keyboard) can be used as rendered in the display.

A number of implementations have been described. Nevertheless, it will be understood that various modifications may be made without departing from the spirit and scope of the description and claims.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example implementations.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A computer program product, the computer program product being tangibly embodied on a non-transitory computer-readable storage medium and comprising instructions that, when executed by at least one computing device, are configured to cause the at least one computing device to:
receive, over a time window, a transcription stream of transcribed text;
determine a first time interval of the time window that includes first transcribed text of the transcribed text;
determine, using a compression ratio machine learning (ML) model, a first compression ratio for the first time interval;
determine a second time interval of the time window that includes second transcribed text of the transcribed text;
determine, using the compression ratio ML model, a second compression ratio for the second time interval; and
input the transcription stream, the first compression ratio, and the second compression ratio into a summarization machine learning (ML) model to obtain a summary stream of summarized text including first summarized text corresponding to the first transcribed text and the first compression ratio, and second summarized text corresponding to the second transcribed text and the second compression ratio.

2. The computer program product of claim 1, wherein the instructions, when executed by the at least one computing device, are further configured to cause the at least one computing device to:
determine the first time interval and the second time interval as each including a pre-defined number of seconds.

3. The computer program product of claim 1, wherein the instructions, when executed by the at least one computing device, are further configured to cause the at least one computing device to:
determine the first time interval and the second time interval based on content of speech from which the transcribed text is transcribed.

4. The computer program product of claim 1, wherein the instructions, when executed by the at least one computing device, are further configured to cause the at least one computing device to:
determine at least one user preference for output of the summary stream; and
input the at least one user preference to the compression ratio ML model.

5. The computer program product of claim 4, wherein the at least one user preference includes a rate at which the first summarized text and the second summarized text are output.

6. The computer program product of claim 1, wherein the instructions, when executed by the at least one computing device, are further configured to cause the at least one computing device to:
determine at least one device characteristic of a device used to output the summary stream; and
input the at least one device characteristic to the compression ratio ML model.

7. The computer program product of claim 1, wherein the instructions, when executed by the at least one computing device, are further configured to cause the at least one computing device to:
determine at least one speech characteristic of speech from which the transcribed text is transcribed; and
input the at least one speech characteristic to the compression ratio ML model.

8. The computer program product of claim 7, wherein the at least one speech characteristic includes one or more of a rate of the speech, a volume of the speech, and a pitch of the speech.

9. The computer program product of claim 1, wherein the instructions, when executed by the at least one computing device, are further configured to cause the at least one computing device to:
determine, using a complexity ML model, a first complexity score for the first time interval;
determine, using the complexity ML model, a second complexity score for the second time interval; and
input the first complexity score and the second complexity score into the summarization ML model to obtain the summary stream including the first summarized text corresponding to the first transcribed text, the first compression ratio, and the first complexity score, and the second summarized text corresponding to the second transcribed text, the second compression ratio, and the second complexity score.

10. The computer program product of claim 9, wherein the instructions, when executed by the at least one computing device, are further configured to cause the at least one computing device to:
determine at least one user preference for a complexity level of the summary stream; and
input the at least one user preference to the complexity ML model.

11. A device comprising:
at least one processor;
at least one memory;
at least one display; and
a rendering engine including instructions stored using the at least one memory, which, when executed by the at least one processor, cause the device to
render a summary stream on the at least one display that includes first summarized text of first transcribed text of a first time interval of a transcription stream, and second summarized text of second transcribed text of a second time interval of the transcription stream,
wherein the first summarized text has a first compression ratio relative to the first transcribed text that is determined by a compression ratio machine learning (ML) model, and the second summarized text has a second compression ratio relative to the second transcribed text that is determined by the compression ratio ML model.

12. The device of claim 11, wherein the rendering engine, when executed by the at least one processor, is further configured to cause the device to:
determine at least one user preference for output of the summary stream; and
input the at least one user preference to the compression ratio ML model.

13. The device of claim 11, wherein the rendering engine, when executed by the at least one processor, is further configured to cause the device to:
determine at least one device characteristic of a device used to output the summary stream; and
input the at least one device characteristic to the compression ratio ML model.

14. The device of claim 11, wherein the rendering engine, when executed by the at least one processor, is further configured to cause the device to:
determine at least one speech characteristic of speech from which the transcribed text is transcribed; and
input the at least one speech characteristic to the compression ratio ML model.

15. The device of claim 11, wherein the rendering engine, when executed by the at least one processor, is further configured to cause the device to:
determine, using a complexity ML model, a first complexity score for the first time interval;
determine, using the complexity ML model, a second complexity score for the second time interval; and
input the first complexity score and the second complexity score into the summarization ML model to obtain the summary stream including the first summarized text corresponding to the first transcribed text, the first compression ratio, and the first complexity score, and the second summarized text corresponding to the second transcribed text, the second compression ratio, and the second complexity score.

16. The device of claim 15, wherein the rendering engine, when executed by the at least one processor, is further configured to cause the device to:
determine at least one user preference for a complexity level of the summary stream; and
input the at least one user preference to the complexity ML model.

17. A method comprising:
receiving a transcription stream of transcribed text;
processing the transcribed text using a compression ratio machine learning (ML) model to determine at least two compression ratios; and
summarizing the transcribed text using the at least two compression ratios to obtain a summary stream that includes first summarized text having a first compression ratio of the at least two compression ratios, relative to a first corresponding portion of the transcribed text, and second summarized text having a second compression ratio of the at least two compression ratios, relative to a second corresponding portion of the transcribed text.

18. The method of claim 17, further comprising:
determining at least one user preference for output of the summary stream; and
inputting the at least one user preference to the compression ratio ML model.

19. The method of claim 17, further comprising:
determining at least one speech characteristic of speech from which the transcribed text is transcribed; and
inputting the at least one speech characteristic to the compression ratio ML model.

20. The method of claim 17, further comprising:
determining, using a complexity ML model, a first complexity score for the first corresponding portion of the transcribed text;
determining, using the complexity ML model, a second complexity score for the second corresponding portion of the transcribed text; and
inputting the first complexity score and the second complexity score into the summarization ML model to obtain the summary stream including the first summarized text corresponding to the first transcribed text, the first compression ratio, and the first complexity score, and the second summarized text corresponding to the second transcribed text, the second compression ratio, and the second complexity score.
